(19) United States
(12) Patent Application Publication
(10) Pub. No.: US 2009/0002763 A1
(43) Pub. Date: Jan. 1, 2009

(54) INFORMATION PROCESSING APPARATUS AND INFORMATION PROCESSING SYSTEM

(75) Inventor: Yukinari SATO, Kyoto (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(73) Assignee: SHARP KABUSHIKI KAISHA, Osaka (JP)

(21) Appl. No.: 12/136,896

(22) Filed: Jun. 11, 2008

(30) Foreign Application Priority Data
Jun. 28, 2007 (JP) 2007-171118

(51) Int. Cl. G06K 15/00

(52) U.S. Cl. 358/1.16; 358/404; 358/1.15

(57) ABSTRACT

An image processing apparatus (information processing apparatus) is capable of storing image data (data) generated by reading a document image into a storage device (storage medium) such as a USB memory. When the storage device cannot store the image data due to a shortage of capacity, the image processing apparatus transfers the image data to a transfer destination indicated by transfer destination information stored in the storage device, and stores the image data in the transfer destination. The transfer destination of the image data is a storing section in the image processing apparatus, or a PC (storage apparatus) etc. connected to the image processing apparatus through a communication network.

### CROSS-REFERENCE TO RELATED APPLICATION

This non-provisional application claims priority under 35 U.S.C. §119(a) on Patent Application No. 2007-171118 filed in Japan on Jun. 28, 2007, the entire contents of which are hereby incorporated by reference.

### BACKGROUND

1. Technical Field

The present invention relates to an information processing apparatus and an information processing system capable of storing data, such as image data generated by reading an image, into a storage medium such as a USB memory.

2. Description of Related Art

An image processing apparatus constructed by incorporating into a single apparatus a plurality of functions, such as a scanner function for creating image data by scanning a document image, a copy function for copying an image, and a printer function for receiving image data from an external apparatus such as a personal computer (PC) and outputting an image, has been put into practical use and is called a multi-function peripheral. Such an image processing apparatus includes therein a storing section, such as a hard disk, for temporarily storing image data to be processed. Moreover, image processing apparatuses capable of not only storing image data temporarily, but also storing image data in a storage apparatus, or in a storage medium such as a USB (Universal Serial Bus) memory, have been put into practical use. Japanese Patent Application Laid-Open No. 11-272576 (1999) discloses an image processing apparatus capable of storing image data in an external storage apparatus connected through a communication network.

### SUMMARY

However, since the size of image data is generally large, an image processing apparatus that stores image data in a storage medium, such as a USB memory, sometimes cannot store the image data due to a shortage of the storage capacity of the storage medium. In this case, it is necessary to replace the storage medium with another storage medium having sufficient storage capacity, or it is necessary to store the image data in the storing section of the image processing apparatus, or in an external storage apparatus connected to the image processing apparatus, and thus there is a problem that the user is required to perform complicated operations.

With the aim of solving the above problem, and it is an object to provide an information processing apparatus and an information processing system which, when a storage medium cannot store data, automatically store the data in another storage means, and are thereby being easy to use.

An information processing apparatus according to a first aspect is an information processing apparatus capable of attaching a removable storage medium thereto and storing data in the attached storage medium, comprising: means for determining whether or not data to be stored can be stored in the attached storage medium; means for, when it is determined that the data cannot be stored, determining whether or not transfer destination information indicating a transfer destination of the data is stored in the storage medium; and means for transferring the data to the transfer destination indicated by the transfer destination information stored in the storage medium when it is determined that the transfer destination information is stored in the storage medium.

An information processing apparatus according to a second aspect is an information processing apparatus capable of attaching a removable storage medium thereto and storing data in the attached storage medium, comprising: means for determining whether or not data to be stored can be stored in the attached storage medium; means for, when it is determined that the data cannot be stored, determining whether or not first authentication information for authenticating the storage medium is stored in the storage medium; determination means for, when it is determined that the first authentication information is stored in the storage medium, determining whether or not the first authentication information and second authentication information for authenticating a transfer destination of the data correctly correspond to each other; and means for transferring the data to the transfer destination authenticated by the second authentication information that correctly corresponds to the first authentication information when it is determined that the first authentication information and the second authentication information correctly correspond to each other.

An information processing apparatus according to a third aspect is characterized by further comprising: a storing section capable of storing data; and means for storing second authentication information for authenticating the storing section, wherein the transfer destination is the storing section.

An information processing apparatus according to a fourth aspect is characterized in that the transfer destination is an external storage apparatus, the information processing apparatus further comprises means for receiving second authentication information transmitted from the external storage apparatus, and the determination means determines whether or not the first authentication information and the received second authentication information correctly correspond to each other.

An information processing apparatus according to a fifth aspect is characterized in that the transfer destination is an external storage apparatus, and the information processing apparatus further comprises: means for transmitting the first authentication information to the external storage apparatus; and means for receiving from the external storage apparatus a determination result indicating whether or not the first authentication information and second authentication information for authenticating the storage apparatus correctly correspond to each other.

An information processing apparatus according to a sixth aspect is characterized by further comprising receiving means for receiving an instruction to retrieve data transferred to the transfer destination in a state in which the storage medium is attached, wherein, when the receiving means receives the instruction, the determination means determines whether or not the first authentication information and the second authentication information for authenticating the transfer destination correctly correspond to each other, and the information processing apparatus further comprises means for obtaining the data from the transfer destination authenticated by the second authentication information that correctly corresponds to the first authentication information when it is determined that the first authentication information and the second authentication information correctly correspond to each other.

An information processing apparatus according to a seventh aspect is characterized in that the data to be stored in the storage medium is image data, and the information processing apparatus further comprises means for generating image data by reading a document image.

An information processing system according to an eighth aspect is an information processing system comprising: an information processing apparatus capable of attaching a removable storage medium thereto and storing data in the attached storage medium; and a storage apparatus connected to the information processing apparatus, wherein the information processing apparatus includes: means for determining whether or not data to be stored can be stored in the attached storage medium; and means for, when it is determined that the data cannot be stored, determining whether or not first authentication information for authenticating the storage medium is stored in the storage medium; and means for transmitting the first authentication information to the storage apparatus when it is determined that the first authentication information is stored in the storage medium, the storage apparatus includes: means for storing second authentication information for authenticating the storage apparatus; means for determining whether or not the first authentication information received from the information processing apparatus and the second authentication information correctly correspond to each other; and means for transmitting a determination result of the means to the information processing apparatus, the information processing apparatus further includes means for transmitting the data to the storage apparatus when the determination result received from the storage apparatus is a result of determination indicating that the first authentication information and the second authentication information correctly correspond to each other, and the storage apparatus further includes means for storing the data received from the information processing apparatus.

In the first and seventh aspects, the information processing apparatus is capable of storing data, such as image data generated by reading a document image, into a recording medium such as a USB memory, and if data cannot be stored in the storage medium due to a shortage of capacity, the information processing apparatus transfers the data to a transfer destination indicated by the transfer destination information stored in the storage medium and stores the data in the transfer destination, such as the storing section in the information processing apparatus, or an external storage apparatus.

In the second, third, fourth and seventh aspects, the information processing apparatus is capable of storing data, such as image data generated by reading a document image, into a recording medium such as a USB memory, and, if data cannot be stored in the storage medium due to a shortage of capacity, the information processing apparatus determines whether or not the first authentication information that authenticates the storage medium and second authentication information for authenticating the transfer destination correctly correspond to each other, transfers the data to the transfer destination authenticated by the second authentication information corresponding to the first authentication information, and stores the data in the transfer destination. The transfer destination of the data is the storing section in the information processing apparatus, or an external storage apparatus.

In the fifth and eighth aspects, if the data cannot be stored in the storage medium, the information processing apparatus transmits the first authentication information for authenticating the storage medium to an external storage apparatus, the storage apparatus determines whether or not the first authentication information and second authentication information for authenticating the storage apparatus correctly correspond to each other, and, when the first authentication information and the second authentication information correspond to each other, the information processing apparatus transmits the data to the storage apparatus, and the storage apparatus stores the data.

In the sixth aspect, the information processing apparatus retrieves data from a transfer destination authenticated by the second authentication information that correctly corresponds to the first authentication information for authenticating the attached storage medium, among transfer destinations of data, such as an internal storing section or an external storage apparatus.

In the first to eighth aspects, even when the data cannot be stored in the storage medium due to a shortage of the storage capacity of the storage medium, a transfer destination is automatically determined and the data is transferred, and therefore the user is not required to replace the storage medium or perform complicated operations to transfer the data. Hence, the present invention exhibits advantageous effects, such as improved operability of the information processing apparatus such as an image processing apparatus, and easy use of data by the user.

The above and further objects and features will more fully be apparent from the following detailed description with accompanying drawings.

### BRIEF DESCRIPTION OF THE SEVERAL VIEWS OF THE DRAWINGS

FIG. 1 is a structural view showing the internal structure of an image processing apparatus as an information processing apparatus;

FIG. 2 is a block diagram showing the electrical structure of an image processing apparatus according to Embodiment 1;

FIG. 3 is an explanatory view for explaining the operation of a detecting section;

FIG. 4 is a block diagram showing the internal structure of a storage device;

FIG. 5 is a flowchart showing the steps of the image data transfer process performed by the image processing apparatus according to Embodiment 1;

FIG. 6 is a block diagram showing the internal structure of a storage device according to Embodiment 2;

FIG. 7 is a block diagram showing the electrical structure of an image processing apparatus according to Embodiment 2;

FIG. 8 is a block diagram showing the internal structure of a PC;

FIG. 9 is a flowchart showing the steps of the image data transfer process performed by the image processing apparatus according to Embodiment 2;

FIG. 10 is a flowchart showing the steps of the image data retrieving process performed by the image processing apparatus according to Embodiment 2;

FIG. 11 is a block diagram showing the structure of an information processing system according to Embodiment 3;

FIG. 12 is a flowchart showing the steps of the image data transfer process performed by the information processing system according to Embodiment 3; and

FIG. 13 is a flowchart showing the steps of the image data retrieving process performed by the information processing system according to Embodiment 3.

### DETAILED DESCRIPTION

The following description will explain in detail some embodiments based on the drawings.

### Embodiment 1

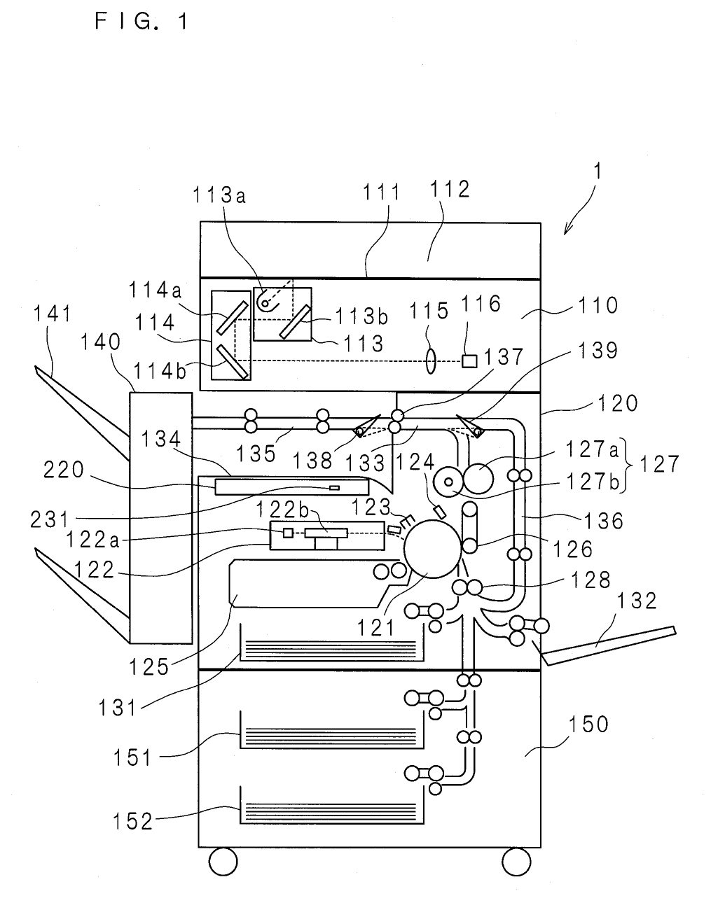

FIG. 1 is a structural view showing the internal structure of an image processing apparatus as an information processing apparatus. An image processing apparatus 1 comprises an image reading section 110 in the upper part, an image forming section 120 in the center part, and a paper supply section 150 in the lower part. Moreover, a document feeding section 112 for supplying a plurality of sheets of document one sheet at a time is provided above the image reading section 110, and a post-processing unit 140 for performing post-processing, such as stapling or sorting, is provided on a side face of the image forming section 120.

The image reading section 110 (image generating section) comprises a document platen 111 composed of a transparent glass plate placed substantially horizontally. The document feeding section 112 is located above the document platen 111 and supplies a plurality of sheets of document one sheet at a time onto the document platen 111. Placed under the document platen 111 are a first scanning unit 113 and a second scanning unit 114 for scanning an image of the document placed on the document platen 111. Further, the image reading section 110 comprises an optical lens 115, and a light receiving section 116 as a photoelectric conversion device. The first scanning unit 113 comprises a light source lamp 113a for exposing the surface of the document placed on the document platen 111 to light, and a mirror 113b for reflecting reflected light from the document of the light from the light source lamp 113a toward the second scanning unit 114. The second scanning unit 114 comprises mirrors 114a and 114b for reflecting the reflected light from the document which has been reflected by the mirror 113b toward the optical lens 115. The optical lens 115 focuses the reflected light from the document which has been reflected by the mirrors 114a and 114b on the light receiving surface of the light receiving section 116. As described above, the image reading section 110 scans the image of the document placed on the document platen 111 by the first scanning unit 113 and second scanning unit 114 and reads the reflected light image of the document image by the light receiving section 116. Image data is generated from the reflected light image of the document image read by the image reading section 110.

The image forming section 120 comprises a photosensitive drum 121, a charger 123 for charging the photosensitive drum 121 to a predetermined electric potential, and a laser scanning unit (LSU) 122 for forming an electrostatic latent image on the photosensitive drum 121 by emitting laser light according to the image data. Further, the image forming section 120 comprises a developer device 125 for developing the electrostatic latent image formed on the photosensitive drum 121 into a visible toner image by supplying toner to the electrostatic latent image, a transfer device 126 for transferring the toner image formed on the photosensitive drum 121 to a sheet, and a cleaning device 124 for collecting toner etc. remaining on the photosensitive drum 121 after the transfer process. The LSU 122 comprises a semiconductor laser 122a for emitting laser light modulated based on the image data, a polygon mirror 122b for scanning the laser light in a main scanning direction by rotation, and a group of lenses, not shown.

The image forming section 120 comprises a fixing unit 127 for applying heat and pressure to a sheet carrying the transferred toner image so as to fix the toner image on the sheet. The fixing unit 127 comprises a pair of a press roller 127a and a heat roller 127b including a heater. Further, formed on the output side of the fixing unit 127 is a switchback path 133 for switching the front and rear ends of a sheet during double-side image formation in which images are formed on both surfaces of the sheet. The switchback path 133 is also used as a transport path for outputting the sheets on which the images are formed. The sheet on which the toner image was fixed in the fixing unit 127 is outputted via the switchback path 133 onto a paper output tray 134 in the main body, or guided to the post-processing unit 140 for post-processing, such as stapling or punching, and then outputted onto the paper output tray 141.

The paper supply tray 131 is provided under the image forming section 120, and a manual feed tray 132 is provided on a side face of the image forming section 120. Moreover, the paper supply section 150 comprises a plurality of paper supply trays 151 and 152. The image forming section 120 comprises transport means such as rollers for transporting a sheet stored in the manual feed tray, or the paper supply tray 131,151 or 152 to a transfer position between the photosensitive drum 121 and the transfer device 126; and a registration roller 128 for temporarily stopping the sheet at a position before the sheet is transported to the photosensitive drum 121. Further, the image forming section 120 comprises a transport path for double-side image formation 136. The transport path for double-side image formation 136 is connected to the switchback path 133 for reversing a sheet, and feeds again the sheet whose front and back surfaces have been reversed during double-side image formation.

Paper output rollers 137 are provided in the outlet section of the switchback path 133. The paper output rollers 137 rotate forward during normal image formation and output the sheet from the switchback path 133, but rotate in the reverse direction while holding the sheet therebetween during double-side image formation and feed the sheet to the transport path for double-side image formation 136. A relay transport path 135 for transporting the sheet to the post-processing unit 140 is provided after the switchback path 133, and a first gate 138 is provided between the paper output rollers 137 and the relay transport path 135 to switch between outputting the recorded sheet outputted from the paper output rollers 137 onto the main-body paper output tray 134 and transporting the sheet to the relay transport path 135. Further, provided between the switchback path 133 and the transport path for double-side image formation 136 is a second gate 139 to switch between outputting the recorded sheet to the main-body paper output tray 134 and transporting the recorded sheet reverse-transported from the switchback path 133 to the transport path for double-side image formation 136 by the reverse of the paper output rollers 37.

Provided on the front face of the image processing apparatus 1 is a control panel 220 which projects so that it is extended from the position of the main-body paper output tray 134. The control panel 220 comprises a display section 220a, such as a liquid crystal panel, for displaying information; and a receiving section 220b, such as key switches or a touch panel, for receiving various kinds of instructions given by the operation of the user. Moreover, on the front face of the image processing apparatus 1, a connection section 231 for connecting a storage device such as a USB memory is provided.

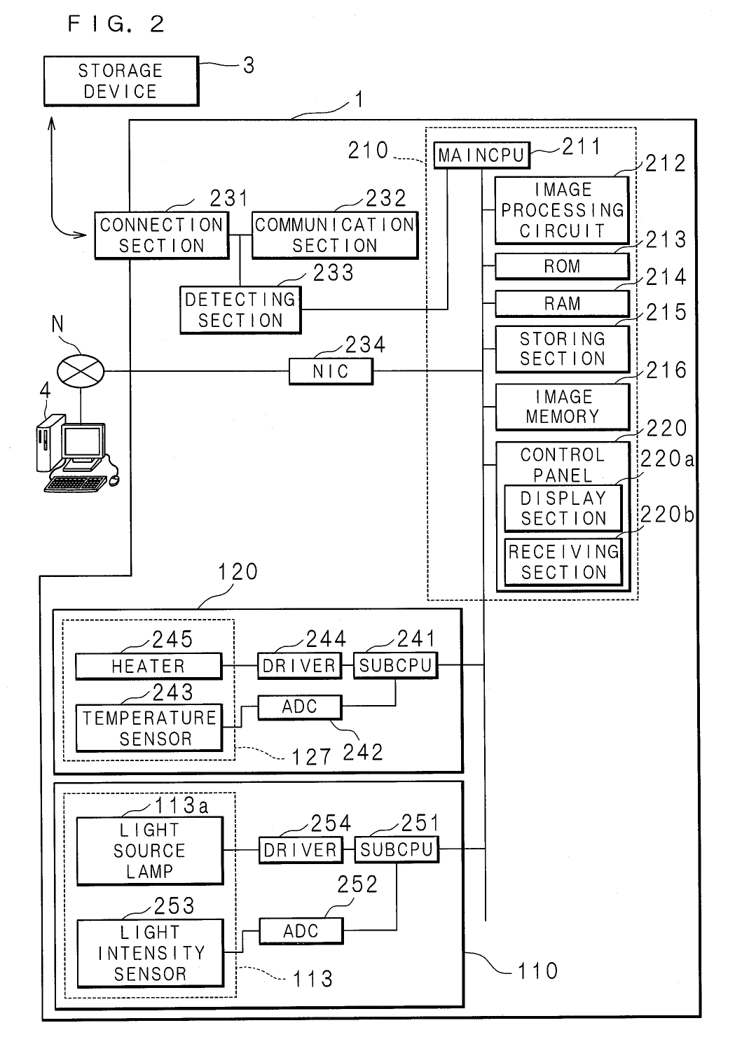

FIG. 2 is a block diagram showing the electrical structure of the image processing apparatus 1 according to Embodiment 1. The image processing apparatus 1 comprises a main controller 210 including therein a main CPU 211 for controlling the entire image processing apparatus 1, a RAM 214 for storing information associated with the processing performed by the main CPU 211, and a ROM 213 for storing a control program. Connected to the main CPU 211 are an image processing circuit 212 (image generating section) for performing image processing such as generation of image data, an image memory 216 for storing image data, a storing section 215 (first storing section) such as a hard disk or a non-volatile semiconductor memory, and the control panel 220. According to the control program stored in the ROM 213, the main CPU 211 executes the process of controlling the operations of the respective sections of the image processing apparatus 1.

Moreover, an NIC (Network Interface Card) 234 (receiving section, transmitting section) is connected to the main CPU 211. The NIC 234 is connected to a LAN or an external communication network N such as the Internet. A PC 4 as a storage apparatus is connected to the communication network N, and the NIC 234 communicates with the PC 4 through the communication network N. The image processing apparatus 1 is capable of performing the process of receiving image data transmitted from the PC 4 by the NIC 234 and forming an image based on the received image data, and the process of transmitting image data generated by reading a document image from the NIC 234 to the PC 4.

The connection section 231 is a connector according to USB standards and connectable to the storage device 3 such as a USB memory. By connecting the storage device 3 to the connection section 231, the storage device 3 is attached to the image processing apparatus 1. The storage device 3 corresponds to a storage medium. Connected to the main CPU 211 is a communication section 232 as an interface for performing data communications with the storage device 3 connected to the connection section 231. Further connected to the main CPU 211 is a detecting section 233 for detecting whether or not data communications with the storage device 3 is possible.

The image forming section 120 comprises a sub CPU 241 for controlling the operation of the image forming section 120, and the sub CPU 241 is connected to the main CPU 211. The fixing unit 127 comprises a heater 245 for heating the heat roller 127b, and a temperature sensor 243 for detecting the temperature of the heat roller 127b. The heater 245 is connected to a driver 244 connected to the sub CPU 241, and turned on by the driver 244 controlled by the sub CPU 241. The temperature sensor 243 is connected to the sub CPU 241 through an A/D converter (ADC) 242, detects the temperature of the heat roller 127b, and inputs the detected temperature data to the sub CPU 241. When the main CPU 241 transmits a predetermined warm-up command to the sub CPU 241, the sub CPU 241 controls the driver 244 to turn on the heater 245 and controls the operation of the driver 244 based on the temperature detected by the temperature sensor 243 so that the surface temperature of the heat roller 127b heated by the heater 245 is substantially fixed at a predetermined temperature. When the surface of the heat roller 127b reaches a predetermined temperature, the sub CPU 241 determines that the image forming process is ready (in the ready state), and reports the main CPU 211 that the image forming process is in the ready state.

The image reading section 110 comprises a sub CPU 251 for controlling the operation of the image reading section 110, and the sub CPU 251 is connected to the main CPU 211. The first scanning unit 113 comprises a light intensity sensor 253 for detecting the intensity of light emitted by the light source lamp 113a. The light source lamp 113a is connected to a driver 254 connected to the sub CPU 251, and turned on by the driver 254 controlled by the sub CPU 251. The light intensity sensor 253 is connected to the sub CPU 251 through an A/D converter (ADC) 252 and inputs the detected light intensity data to the sub CPU 251. When the main CPU 211 transmits a predetermined warm-up command to the sub CPU 251, the sub CPU 251 controls the driver 254 to turn on the light source lamp 113a and controls the operation of the driver 254 based on the light intensity detected by the light intensity sensor 253 so that the intensity of light emitted by the light source lamp 113a is substantially fixed at a predetermined intensity. When the intensity of light emitted by the light source lamp 113a reaches the predetermined intensity, the sub CPU 251 determines that the image reading process is ready (in the ready state), and reports the main CPU 211 that the image reading process is in the ready state.

Connected to the sub CPUs 241 and 251 are various components, not shown, such as motors, clutches, solenoids and sensors, constituting the image forming section 120 and the image reading section 110. The sub CPUs 241 and 251 read the detection data of the sensors at predetermined timing when performing the image forming process and the image reading process, and operate various components according to the detected data.

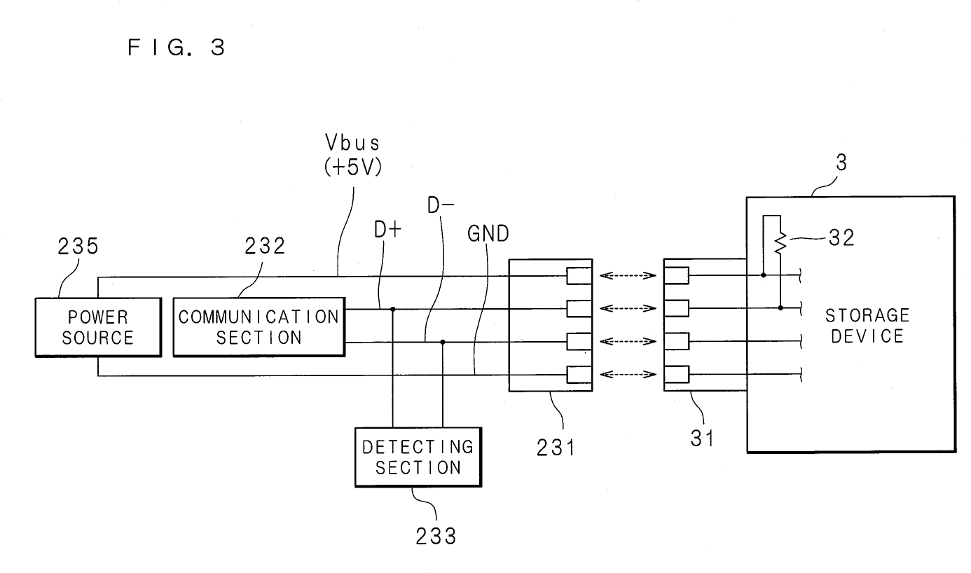

FIG. 3 is an explanatory view for explaining the operation of the detecting section 233. Connected to the connection section 231 are a power line Vbus and a ground line GND connected to a power source 235 of the image processing apparatus 1, and data input and output lines D+ and D− connected to the communication section 232 and the detection section 233. The storage device 3 has a connection terminal 31 to be connected to the connection section 231. Lines corresponding to the power line Vbus, ground line GND and data input and output lines D+ and D− are connected to the connection terminal 31 in the same manner. The power line Vbus is a line for supplying electric power to the storage device 3 at +5 V, and the power source 235 supplies electric power through the power line Vbus to the storage device 3 connected to the connection section 231. Provided in the storage device 3 is a pull-up resistor 32 for pulling up the data input and output line D+ to the electric potential of the power line Vbus. Note that the storage device 3 may be designed so that the pull-up resister 32 pull-ups the data input and output line D− to the electric potential of the power line Vbus. When the storage device 3 is connected to the connection section 231, the data input and output line D+ or D− becomes almost the same electric potential as the power line Vbus. The detecting section 233 detects the electric potential of the data input and output lines D+ and D−. When the data input and output line D+ or D− becomes almost the same electric potential as the power line Vbus, the process of reporting the main CPU 211 that the data communication between the storage device 3 and the image processing apparatus 1 is in the ready state is performed.

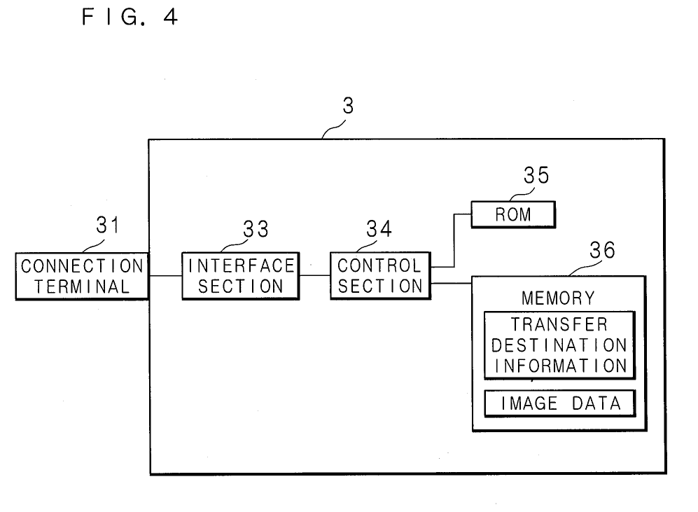

FIG. 4 is a block diagram showing the internal structure of the storage device 3. The storage device 3 is a USB memory and includes an interface section 33 for performing communications through a connection terminal 31, a control section 34 for controlling the input and output of data, a ROM 35 for storing a control program etc., and a memory 36 capable of storing image data. In addition to image data, the memory 36 can store transfer destination information indicating a destination to which the image data is transferred in the event of a shortage of storage capacity. The transfer destination information is information indicating the storing section 215 of the image processing apparatus 1 to which the storage device 3 is connected, or information such as an IP address or a MAC address indicating a specific PC 4. Alternatively, the transfer destination information may be an electronic mail address.

The image processing apparatus 1 having the above-mentioned structure is a multi-function peripheral capable of executing the process of copying a document image, the process of forming an image based on image data, and the process of reading an image. Next, the operation of the image processing apparatus 1 will be explained. First, the process of copying a document image will be explained. In a state in which a document is placed on the document platen 111, or in a state in which a document is set in the document feeding section 112, the user operates the receiving section 220b of the control panel 220, and thereby inputs conditions, such as the number of copies to be produced or the magnification ratio of copying, and a copying start instruction. When the copying start instruction is inputted, the main CPU 211 activates a main drive motor, not shown, so that drive gears, not shown, rotate. A sheet is supplied from the manual feed tray 132 or the paper supply tray 131, 151, or 152, and the supplied sheet is transported to the registration roller 128. Here, the sheet is temporarily stopped for synchronization with the front end of the image on the photosensitive drum 121, and the front end of the sheet is pressed evenly against the registration roller 128 to adjust the position of the front end of the sheet.

In the image reading section 110, the light source lamp 113a is turned on and the first scanning unit 113 is moved to start the exposure operation. The reflected light on the document image surface of the light emitted by the light source lamp 113a is received by the light receiving section 116 via the mirrors 113b, 114a, 114b and the optical lens 115, and read as image information. The read image information is converted into image data as digital data in the image processing circuit 212. The image data is image-processed under the set conditions, stored temporarily in the image memory 216 and then supplied to the LSU 122 by the main CPU 211.

The surface of the photosensitive drum 121 rotating at a predetermined speed is evenly charged to a predetermined electric potential by receiving charges from the charger 123. The LSU 122 drives the semiconductor laser 122a based on the image data supplied from the main CPU 211, and irradiates laser light modulated based on the image data onto the surface of the photosensitive drum 121 through the polygon mirror 122b rotating at a predetermined speed. With the irradiation of laser light by the LSU 122, an electrostatic latent image based on the image data is formed on the surface of the photosensitive drum 121. Toner is supplied from the developer device 125 to the surface of the photosensitive drum 121 on which the electrostatic latent image is formed, and the electrostatic latent image is developed into a visible toner image.

With the registration roller 128 which starts rotating in synchronization with the rotation of the photosensitive drum 121, the sheet is transported between the photosensitive drum 121 and the transfer device 126, and the toner image on the surface of the photosensitive drum 121 is transferred by the transfer device 126. The toner remaining on the surface of the photosensitive drum 121 is removed and collected together with paper dust by the cleaning device 124. The sheet to which the toner image has been transferred is transported to the fixing unit 127, and heat and pressure are applied to the sheet while the sheet is passing between the heat roller 127b and the press roller 127a. With the application of heat and pressure by the heat roller 127b and the press roller 127a, the toner image transferred onto the sheet melts and is firmly fixed to the sheet surface. By fixing the toner image, a copy of the document image is formed on the sheet. The sheet on which the image has been formed is sent to the post-processing unit 140, or outputted onto the main-body paper output tray 134, by the paper output rollers 137.

Next, the process of forming an image based on image data will be explained. When image data transmitted from the PC 4, such as a PC, through the communication network N is received by the NIC 234, the main CPU 211 performs appropriate image processing and then inputs the image data into the LSU 122. Like the above-mentioned copying process, in the image forming section 120, an image is formed based on the image data inputted into the LSU 122. The image processing apparatus 1 is also capable of forming an image based on image data stored in the storage device 3. In a state in which the storage device 3 is connected to the connection section 231, the user inputs an image forming instruction by operating the receiving section 220b of the control panel 220. The main CPU 211 causes the communication section 232 to transmit an image data transfer request to the storage device 3 through the connection section 231. The control section 34 of the storage device 3 retrieves image data from the memory 36, and causes the interface section 33 to transmit the image data to the image processing apparatus 1 through the connection terminal 31. The image processing apparatus 1 receives the image data by the communication section 232, and the main CPU 211 inputs the image data into the LSU 122. The image forming section 120 performs the process of forming an image in the same manner.

Next, the process of reading a document image will be explained. In a state in which a document is placed on the document platen 111, or a state in which a document is set in the document feeding section 112, the user inputs an instruction to start reading an image by operating the receiving section 220b of the control panel 220. Like the above-mentioned copying process, the image reading section 110 reads image information, and the image processing circuit 212 converts the image information into image data. The image data thus generated is stored temporarily in the image memory 216 and then stored in the storing section 215, or transmitted from the NIC 234 to the PC4 specified by the user.

The image processing apparatus 1 as an information processing apparatus is also capable of performing the process of storing the image data generated by reading a document image into the storage device 3. At this time, if the storage device 3 cannot store the image data due to a shortage of the storage capacity of the storage device 3, the image processing apparatus 1 performs the process of storing the image data by automatically transferring the image data to another transfer destination.

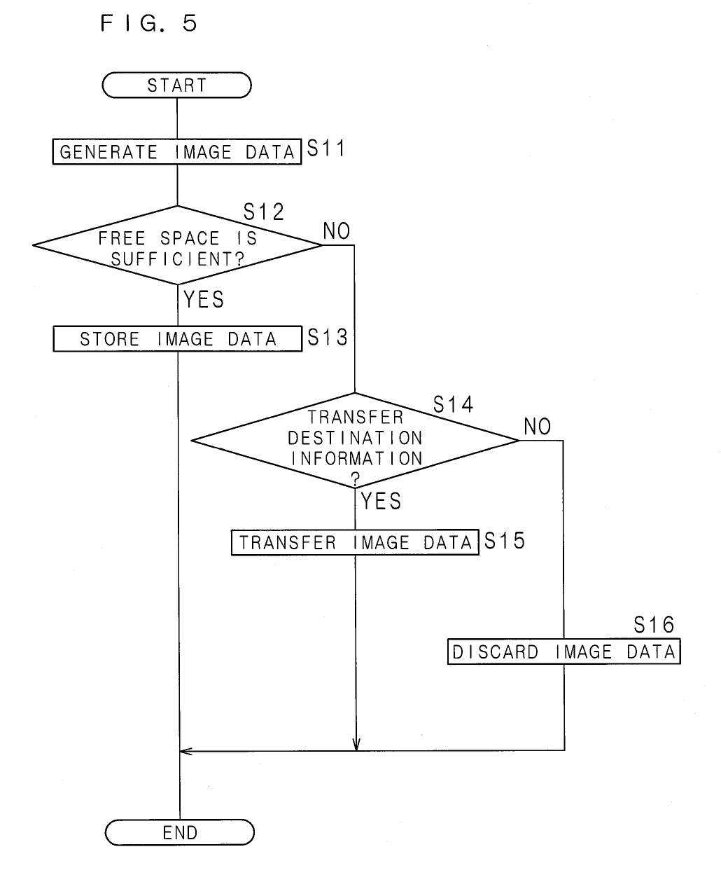

FIG. 5 is a flowchart showing the steps of the image data transfer process performed by the image processing apparatus 1 according to Embodiment 1. When an instruction to start reading a document is inputted in a state in which the storage device 3 is connected to the connection section 231, the image reading section 110 reads the image information and the image processing circuit 212 converts the image information into image data, and thereby the image processing apparatus 1 generates image data (S11). The main CPU 211 stores temporarily the generated image data in the image memory 216, checks the free space of the memory 36 of the storage device 3 connected to the connection section 231 and determines whether or not the free space of the memory 36 of the storage device 3 is sufficient for storing the image data stored in the image memory 216 (S12). If the free space is sufficient (S12: YES), the main CPU 211 causes the communication section 232 to transmit the image data stored in the image memory 216 to the storage device 3, and the storage device 3 receives the image data by the interface section 33 and the control section 34 stores the received image data into the memory 36 (S13).

In step S12, if the memory 36 does not have sufficient free space and the storage device 3 cannot store the image data (S12: NO), the main CPU 211 determines whether or not the storage device 3 stores transfer destination information in the memory 36 (S14). If the storage device 3 stores the transfer destination information (S14: YES), the main CPU 211 transfers the image data stored in the image memory 216 to the transfer destination indicated by the transfer destination information stored in the memory 36 of the storage device 3 (S15). Here, if the transfer destination information indicates the storing section 215 of the image processing apparatus 1, the main CPU 211 stores the image data in the storing section 215. On the other hand, if the transfer destination information indicates a specific PC 4, the main CPU 211 causes the NIC 234 to transmit the image data through the communication network N to the PC 4 indicated by the transfer destination information. If the transfer destination information is an electronic mail address, the main CPU 211 creates an electronic mail to which the image data is attached, and causes the NIC 234 to transmit the electronic mail to the electronic mail address indicated by the transfer destination information.

In step S14, if the storage device 3 does not store transfer destination information (S14: NO), the main CPU 211 displays in the display section 220a of the control panel 220 an error message indicating that the image data cannot be stored or transferred, and discards the image data stored in the image memory 216 (S16). Here, the image processing apparatus 1 completes the image data transfer process.

As described in detail above, when the image processing apparatus 1 as an information processing device tries to store the image data in the storage device 3 but cannot store the image data, the image processing apparatus 1 transfers the image data to a transfer destination indicated by the transfer destination information stored in the storage device 3, and stores the image data in the transfer destination. The user can use the image data stored in the transfer destination. For example, when the image data is stored in the storing section 215, the user can use the image data by retrieving the image data from the storing section 215 through the communication network N. On the other hand, when the image data is transferred to the PC 4, the user can use the image data with the PC 4.

In this embodiment, even when the image data cannot be stored due to a shortage of the storage capacity of the storage device 3, a transfer destination is automatically determined and the image data is transferred. Therefore, the user is not required to replace the storage device 3, or perform a complicated operation to transfer the image data. Thus, the operability of the image processing apparatus 1 is improved, and the user can use the image data more easily.

### Embodiment 2

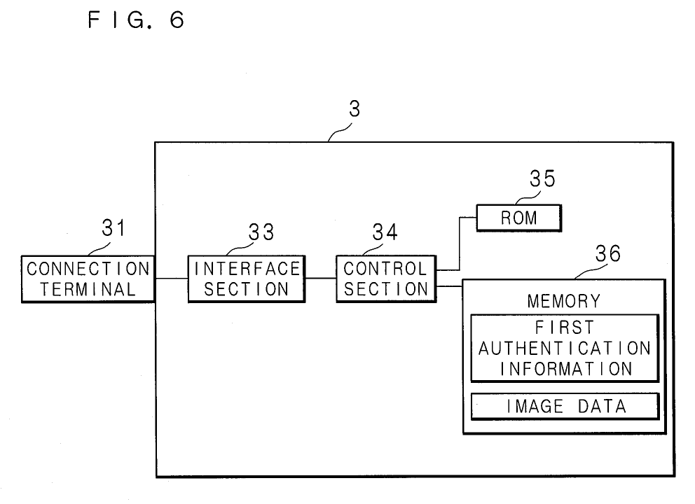

FIG. 6 is a block diagram showing the internal structure of the storage device 3 according to Embodiment 2. The storage device 3 stores first authentication information for authenticating the storage device 3 in the memory 36. Note that the storage device 3 may be embodied to store the first authentication information in the ROM 35. Since other internal structure of the storage device 3 is the same as that explained in Embodiment 1 with reference to FIG. 4, corresponding parts are designated with the same reference codes and the explanation thereof will be omitted.

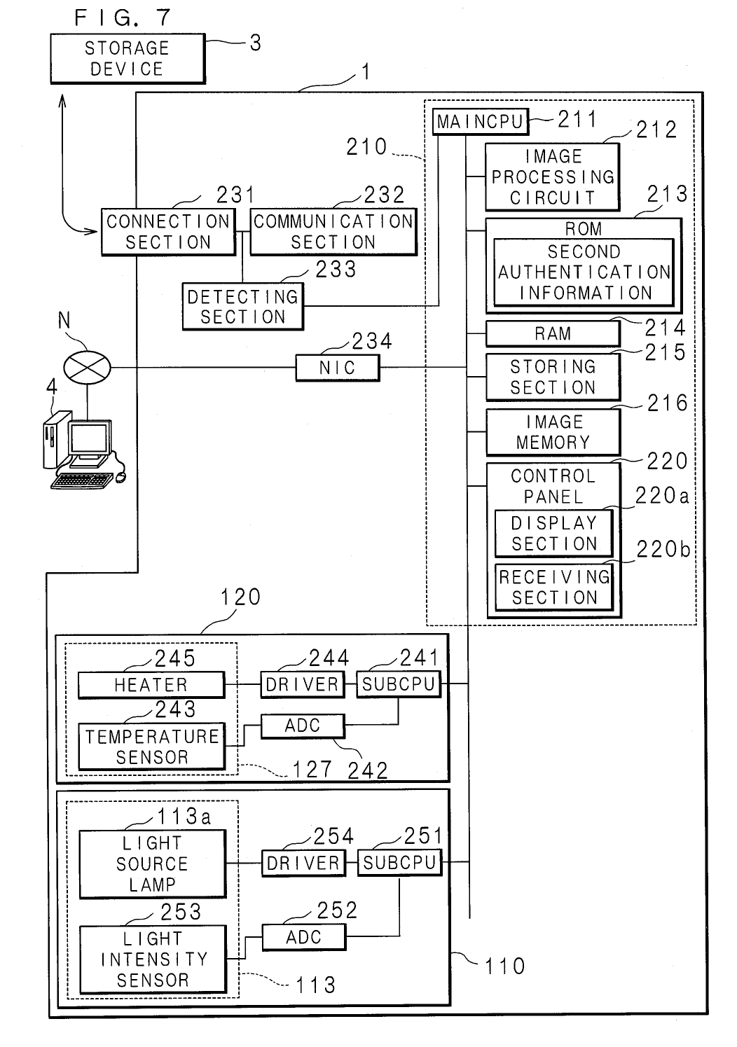

The internal structure of the image processing apparatus 1 according to Embodiment 2 is the same as that explained in Embodiment 1 with reference to FIG. 1, and therefore the explanation thereof will be omitted. FIG. 7 is a block diagram showing the electrical structure of the image processing apparatus 1 according to Embodiment 2. The ROM 213 (second storing section) stores second authentication information for authenticating the storing section 215 of the image processing apparatus 1. Note that the image processing apparatus 1 may be embodied to store the second authentication information in the storing section 215 (second storing section). The image processing apparatus 1 may store a plurality of pieces of second authentication information to correspond to a plurality of storage devices 3. Since other electrical structure of the image processing apparatus 1 is the same as that explained in Embodiment 1 with reference to FIG. 2, corresponding parts are designated with the same reference codes and the explanation thereof will be omitted.

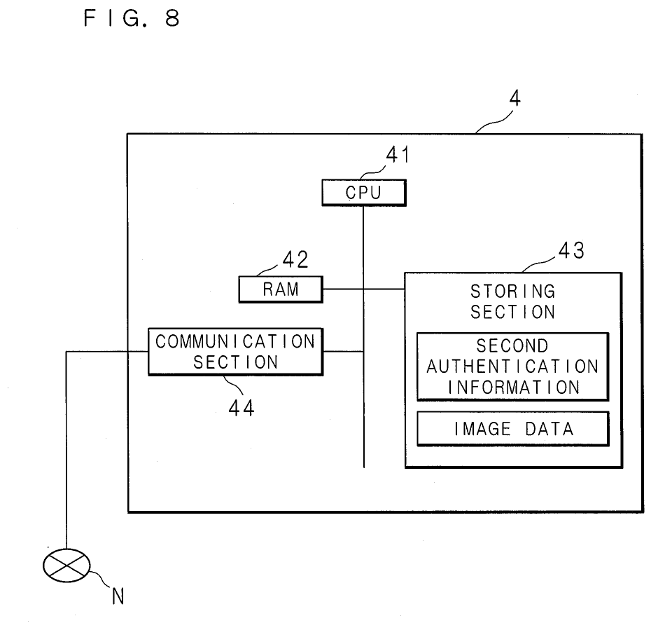

FIG. 8 is a block diagram showing the internal structure of the PC 4. The PC 4 comprises a CPU 41, a RAM 42, a storing section 43 such as a hard disk, and a communication section 44 connected to the communication network N. The storing section 43 is capable of storing image data and stores the second authentication information for authenticating the PC 4. The storing section 43 may be embodied to store a plurality of pieces of second authentication information.

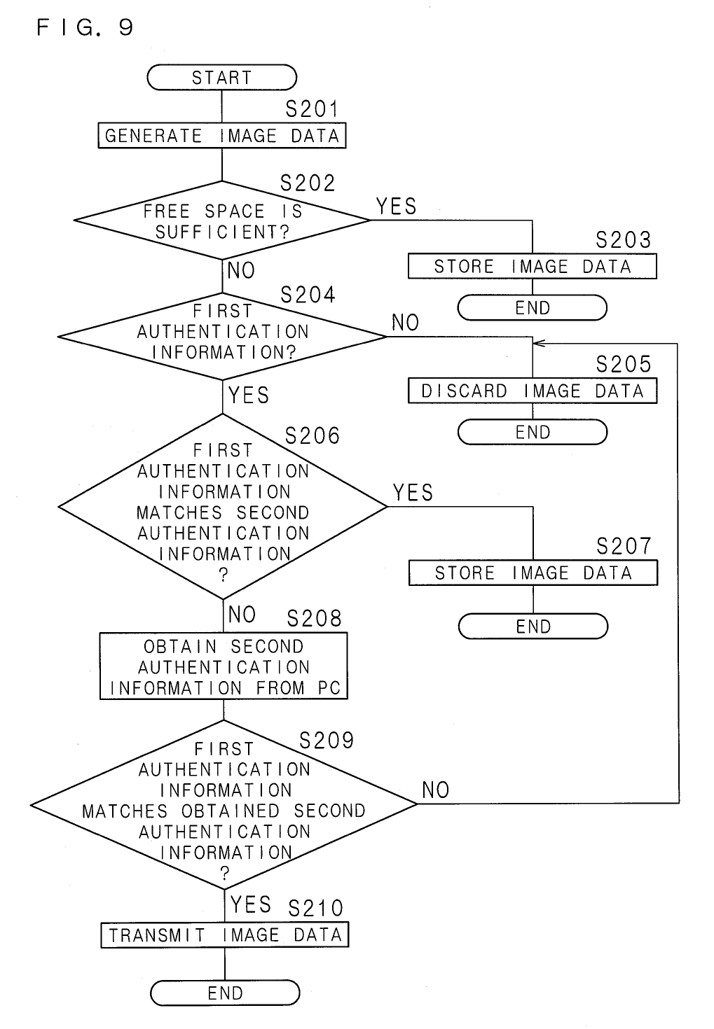

FIG. 9 is a flowchart showing the steps of the image data transfer process performed by the image processing apparatus 1 according to Embodiment 2. When an instruction to start reading a document is inputted in a state in which the storage device 3 is connected to the connection section 231, the image reading section 110 reads the image information and the image processing circuit 212 converts the image information into image data, and thereby the image processing apparatus 1 generates image data (S201). The main CPU 211 stores temporarily the generated image data in the image memory 216, checks the free space of the memory 36 of the storage device 3 connected to the connection section 231, and determines whether or not the free space of the memory 36 of the storage device 3 is sufficient for storing the image data stored in the image memory 216 (S202). If the free space is sufficient (S202: YES), the main CPU 211 causes the communication section 232 to transmit the image data stored in the image memory 216 to the storage device 3, the storage device 3 receives the image data by the interface section 33, and the control section 34 stores the received image data in the memory 36 (S203).

In step S202, if the memory 36 does not have sufficient free space and the storage device 3 cannot store the image data (S202: NO), the main CPU 211 determines whether or not the storage device 3 stores the first authentication information in the memory 36 (S204). If the storage device 3 does not store the first authentication information (S204: NO), the main CPU 211 displays in the display section 220a of the control panel 220 an error message indicating that the image data cannot be stored or transferred and discards the image data stored in the image memory 216 (S205), and completes the process. If the storage device 3 stores the first authentication information (S204: YES), the main CPU 211 retrieves the first authentication information stored in the memory 36 of the storage device 3 and determines whether or not the retrieved first authentication information matches any piece of the second authentication information stored in the ROM 213 (S206). If the first authentication information matches a piece of the second authentication information (S206: YES), the main CPU 211 stores the image data stored in the image memory 216 into the storing section 215 (S207). At this time, the storing section 215 may store the image data in association with the second authentication information that matches the first authentication information.

In step S206, if the first authentication information does not match any piece of the second authentication information (S206: NO), the main CPU 211 obtains the second authentication information from the PC 4 connected to the communication network N (S208). At this time, the main CPU 211 causes the NIC 234 to transmit a request for the second authentication information to the PC 4 through the communication network N, and the CPU 41 of the PC 4 causes the communication section 44 to transmit the second authentication information stored in the storing section 43 to the image processing apparatus 1 through the communication network N. In the case where a plurality of PCs 4 are connected to the communication network N, the image processing apparatus 1 obtains the second authentication information from each of the PCs 4.

Next, the main CPU 211 determines whether or not the first authentication information matches any piece of the obtained second authentication information (S209). If the first authentication information does not match any piece of the obtained second authentication information (S209: NO), the main CPU 211 proceeds the process to step S205. If the first authentication information matches a piece of the obtained second authentication information (S209: YES), the main CPU 211 causes the NIC 234 to transmit the image data stored in the image memory 216 to the PC 4 authenticated by the second authentication information that matches the first authentication information (S210). In the PC 4, the image data is received by the communication section 44, and the CPU 41 stores the image data in the storing section 43. Here, the image processing apparatus 1 completes the image data transfer process.

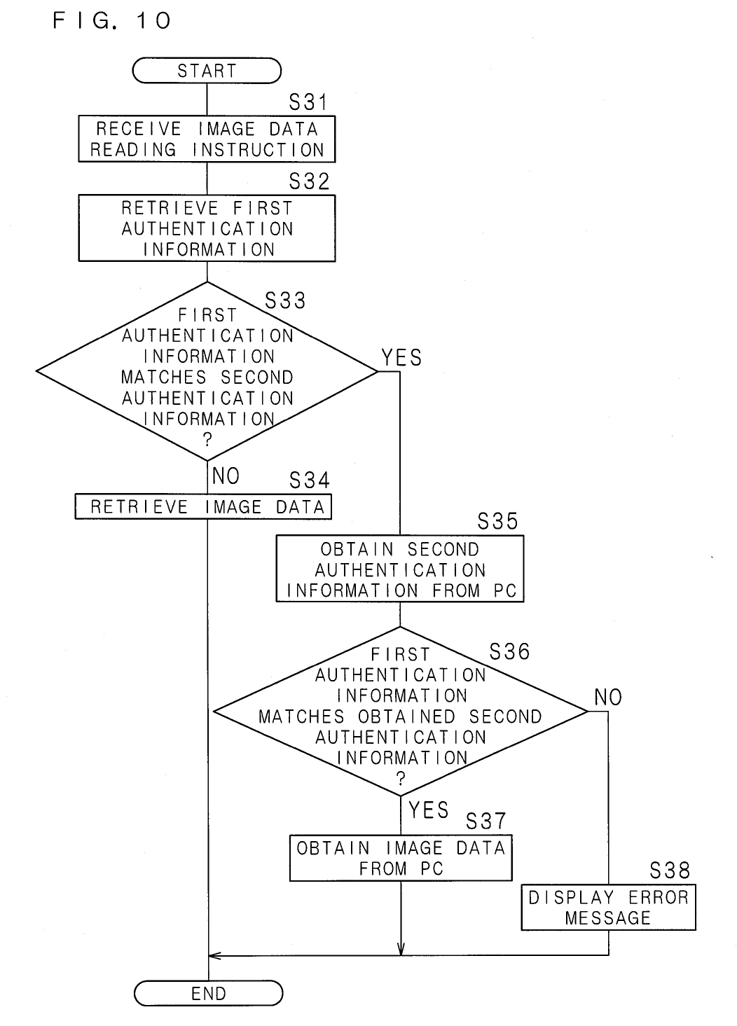

FIG. 10 is a flowchart showing the steps of the image data retrieving process performed by the image processing apparatus 1 according to Embodiment 2. The user operates the receiving section 220b of the control panel 220 in a state in which the storage device 3 is connected to the connection section 231, and thereby the image processing apparatus 1 receives an image data reading instruction in the receiving section 220b of the control panel 220 (S31). The main CPU 211 retrieves the first authentication information stored in the memory 36 of the storage device 3 (S32), and determines whether or not the retrieved first authentication information matches any piece of the second authentication information stored in the ROM 213 (S33). If the first authentication information matches a piece of the second authentication information (S33: YES), the main CPU 211 retrieves the image data stored in the storing section 215 into the image memory 216 (S34). At this time, the main CPU 211 may retrieve the image data stored in the storing section 215 in association with the second authentication information that matches the first authentication information.

In step S33, if the first authentication information does not match any piece of the second authentication information (S33: NO), the main CPU 211 obtains the second authentication information from the PC 4 connected to the communication network N (S35). At this time, the main CPU 211 causes the NIC 234 to transmit a request for the second authentication information to the PC 4 through the communication network N, and the CPU 41 of the PC 4 causes the communication section 44 to transmit the second authentication information stored in the storing section 43 to the image processing apparatus 1 through the communication network N. Next, the main CPU 211 determines whether or not the first authentication information matches any piece of the obtained second authentication information (S36). If the first authentication information matches a piece of the obtained second authentication information (S36: YES), the main CPU 211 obtains the image data from the PC 4 authenticated by the second authentication information that matches the first authentication information (S37). At this time, the main CPU 211 causes the NIC 234 to transmit a request for the image data to the PC 4 through the communication network N, and the CPU 41 of the PC 4 causes the communication section 44 to transmit the image data stored in the storing section 43 to the image processing apparatus 1 through the communication network N. The image processing apparatus 1 receives the image data from the PC 4 by the NIC 234 and stores the image data in the image memory 216. If the first authentication information does not match any piece of the obtained second authentication information (S36: NO), the main CPU 211 displays in the display section 220a of the control panel 220 an error message indicating that the image data cannot be retrieved (S38).

Here, the image processing apparatus 1 completes the image data retrieving process. The image processing apparatus 1 stores the retrieved image data in the image memory 216 and executes various kinds of image processing according to an instruction inputted by the user by operating the receiving section 220b of the control panel 220. For example, the image processing apparatus 1 performs the process of forming an image based on the retrieved image data. Or, for example, the image processing apparatus 1 performs the process of storing the retrieved image data in the storage device 3, or the process of transmitting the retrieved image data to an arbitrary PC 4.

In this embodiment, as described in detail above, when the image processing apparatus 1 tries to store image data in the storage device 3 but cannot store the image data, it determines whether or not the first authentication information for authenticating the storage device 3 and the second authentication information for authenticating the transfer destination match each other, transfers the image data to the transfer destination authenticated by the second authentication information that matches the first authentication information, and stores the image data in the transfer destination. In this embodiment, when retrieving the image data, the image processing apparatus 1 retrieves the image data from the transfer destination authenticated by the second authentication information that matches the first authentication information.

In this embodiment, when the image data cannot be stored due to a shortage of the storage capacity of the storage device 3, the image data is transferred to another storing means without requiring the user to perform complicated operations, and thus the operability of the image processing apparatus 1 is improved. Moreover, when retrieving the image data, it is possible to retrieve the image data by just connecting the storage device 3. Therefore, although the user does not know where the image data is transferred, he or she can easily use the transferred image data.

Although this embodiment illustrates the process of obtaining the second authentication information for authenticating the PC 4 when the first authentication information and second authentication information for authenticating the storing section 215 do not match, the image processing apparatus 1 as an information processing apparatus may be embodied to determine whether or not the first authentication information and the second authentication information for authenticating the PC 4 match each other in advance. Moreover, although this embodiment illustrates an example in which the image processing apparatus 1 obtains the second authentication information for authenticating the PC 4 from the PC 4 as the need arises, the image processing apparatus 1 as an information processing apparatus may be embodied to store the second authentication information for authenticating the PC 4 connected through the communication network N in the storing section 215 in advance and execute a necessary process using the stored second authentication information.

The image processing apparatus 1 as an information processing apparatus may be embodied to perform a combination of the processes of Embodiments 1 and 2. In other words, when the storage device 3 stores the transfer destination information together with the first authentication information, the image processing apparatus 1 obtains the second authentication information for authenticating the transfer destination indicated by the transfer destination information and makes a determination. When the first authentication information and the second authentication information match, the image processing apparatus 1 stores the image data in the storing section 215 if the transfer destination is the storing section 215, or transmits the image data to the PC 4 if the transfer destination is the PC 4.

### Embodiment 3

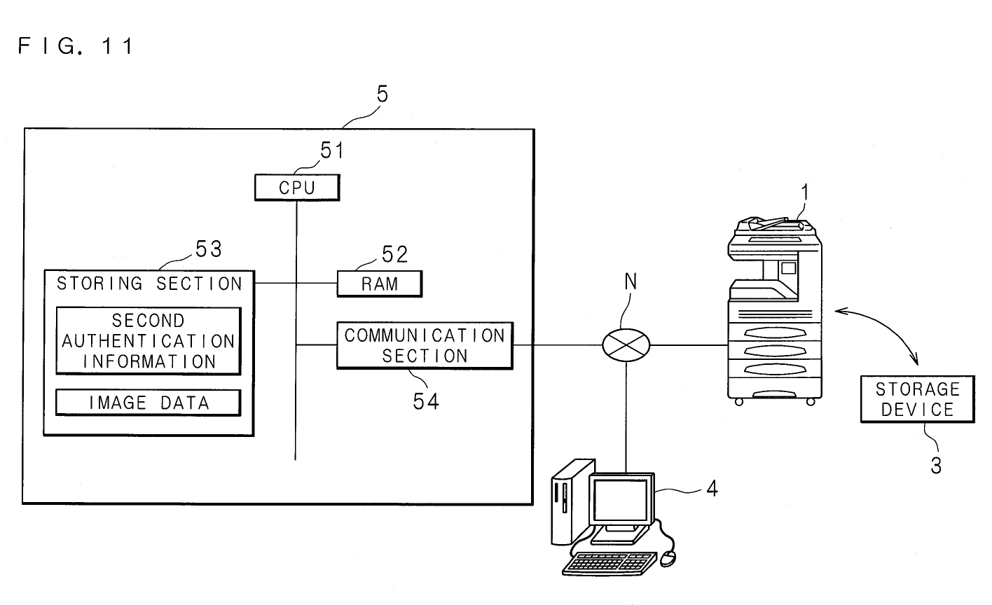

FIG. 11 is a block diagram showing the structure of an information processing system according to Embodiment 3. The storage device 3 is connectable to the image processing apparatus 1 as an information processing apparatus, and the image processing apparatus 1 is connected to the communication network N. In addition, the PC 4 and an authentication server apparatus 5 as a storage apparatus are connected to the communication network N. The authentication server apparatus 5 comprises a CPU 51, a RAM 52, a storing section 53 such as a hard disk, and a communication section 54 (transmitting section) connected to the communication network N. The storing section 53 is capable of storing image data and stores the second authentication information for authenticating the authentication server apparatus 5. The storing section 53 may be embodied to store a plurality of pieces of second authentication information. Since the internal structure and electrical structure of the image processing apparatus 1 are similar to those in Embodiment 1, the explanation thereof will be omitted. The internal structure of the storage device 3 is similar to that explained in Embodiment 2 with reference to FIG. 6, and the first authentication information for authenticating the storage device 3 is stored in the memory 36.

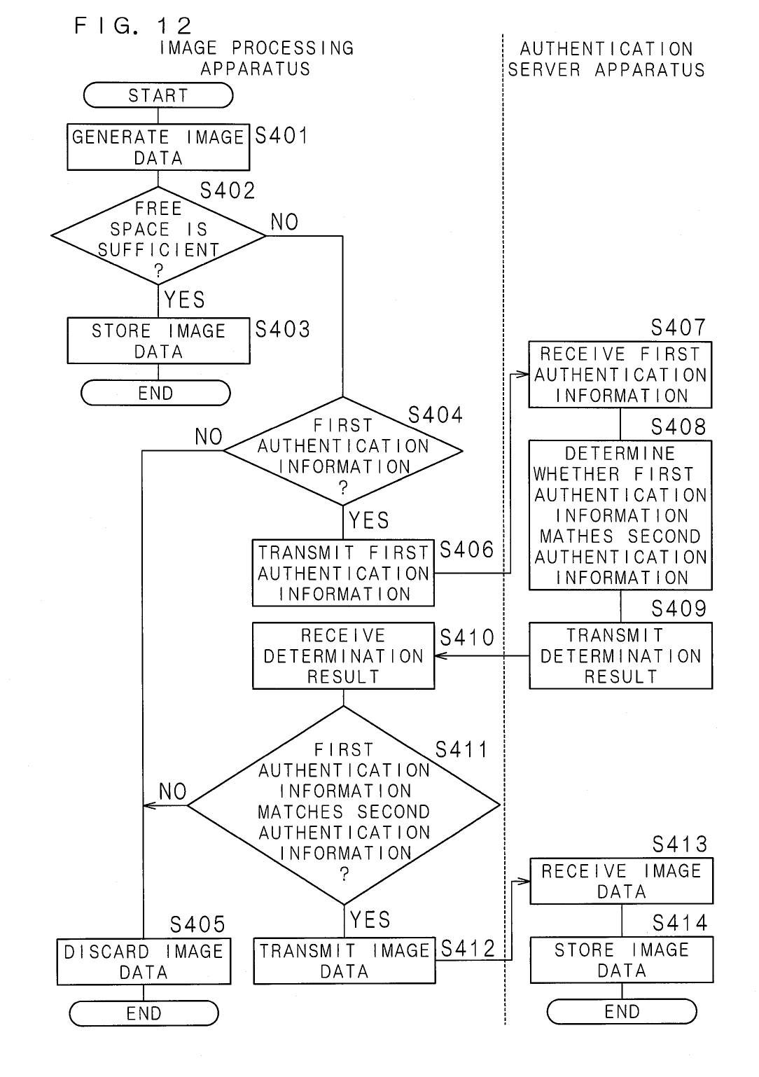

FIG. 12 is a flowchart showing the steps of the image data transfer process performed by the information processing system according to Embodiment 3. When an instruction to start reading an image is inputted in a state in which the storage device 3 is connected to the connection section 231, the image reading section 110 reads the image information and the image processing circuit 212 converts the image information into image data, and thereby the image processing apparatus 1 generates image data (S401). The main CPU 211 of the image processing apparatus 1 temporarily stores the generated image data in the image memory 216, and determines whether the free space of the memory 36 of the storage device 3 connected to the connection section 231 is sufficient for storing the image data stored in the image memory 216 (S402). If the free space is sufficient (S402: YES), the main CPU 211 causes the communication section 232 to transmit the image data stored in the image memory 216 to the storage device 3, and, in the storage device 3, the interface section 33 receives the image data and the control section 34 stores the received image data in the memory 36 (S403).

In step S402, if the memory 36 does not have sufficient free space and the storage device 3 cannot store the image data (S402: NO), the main CPU 211 determines whether or not the storage device 3 stores the first authentication information in the memory 36 (S404). If the storage device 3 does not store the first authentication information (S404: NO), the main CPU 211 displays an error message indicating that the image data cannot be stored or transferred in the display section 220a of the control panel 220 and discards the image data stored in the image memory 216 (S405), and completes the process.

In step S404, if the storage device 3 stores the first authentication information (S404: YES), the main CPU 211 retrieves the first authentication information stored in the memory 36 of the storage device 3 and causes the NIC 234 to transmit the retrieved first authentication information to the authentication server apparatus 5 through the communication network N (S406). The authentication server apparatus 5 receives the first authentication information by the communication section 54 (S407). The CPU 51 of the authentication server apparatus 5 determines whether or not the received first authentication information matches any piece of the second authentication information stored in the storing section 53 (S408), and causes the communication section 54 to transmit the determination result to the image processing apparatus 1 through the communication network N (S409).

The image processing apparatus 1 receives the determination result by the NIC 234 (S410), and the main CPU 211 determines whether or not the received determination result is the result of determination indicating that the first authentication information and the second authentication information match each other (S411). If the determination result is the result of determination indicating that the first authentication information and the second authentication information do not match (S411: NO), the main CPU 211 proceeds the process to step S405. If the determination result is the result of determination indicating that the first authentication information and the second authentication information match (S411: YES), the main CPU 211 causes the NIC 234 to transmit the image data stored in the image memory 216 to the authentication server apparatus 5 (S412). The authentication server apparatus 5 receives the image data by the communication section 54 (S413), and the CPU 51 stores the received image data in the storing section 53 (S414). At this time, the storing section 53 may store the image data in association with the second authentication information that matches the first authentication information. Here, the information processing system completes the image data transfer process.

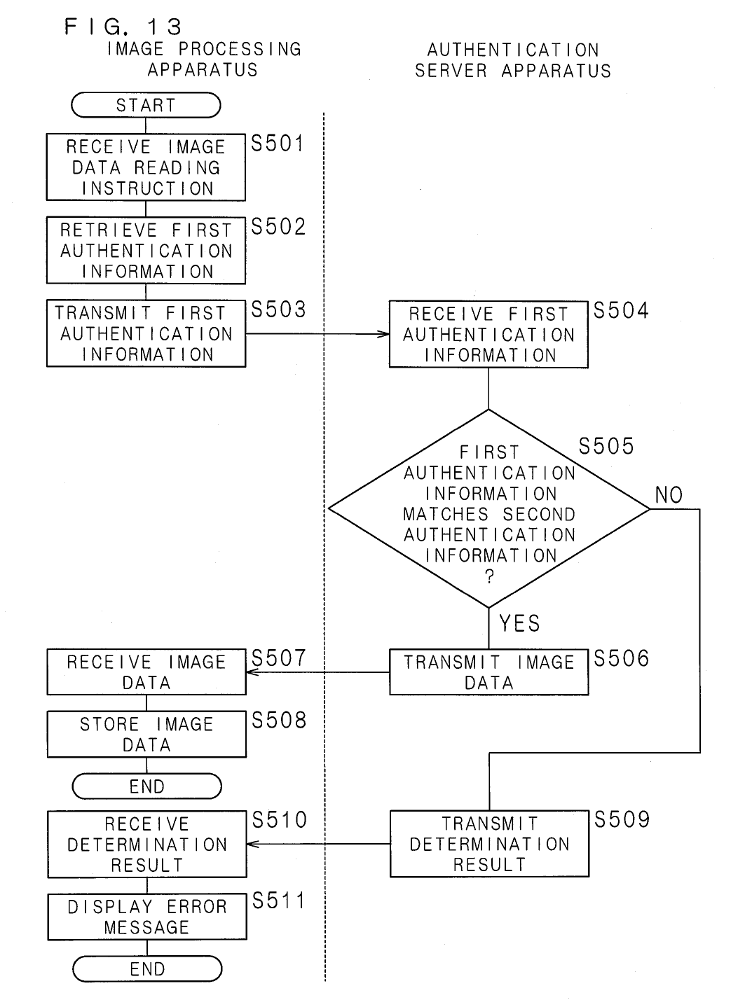

FIG. 13 is a flowchart showing the steps of the image data retrieving process performed by the information processing system according to Embodiment 3. The user operates the receiving section 220b of the control panel 220 in a state in which the storage device 3 is connected to the connection section 231, and thereby the image processing apparatus 1 receives an image data retrieving instruction in the receiving section 220b of the control panel 220 (S501). The main CPU 211 retrieves the first authentication information stored in the memory 36 of the storage device 3 (S502), and causes the NIC 234 to transmit the retrieved first authentication information to the authentication server apparatus 5 (S503).

The authentication server apparatus 5 receives the first authentication information by the communication section 54 (S504), and the CPU 51 determines whether or not the received first authentication information matches any piece of the second authentication information stored in the storing section 53 (S505). If the first authentication information matches the second authentication information (S505: YES), the CPU 51 retrieves the image data stored in the storing section 53 and causes the communication section 54 to transmit the image data to the image processing apparatus 1 (S506). At this time, the CPU 51 may retrieve the image data stored in the storing section 53 in association with the second authentication information that matches the first authentication information. The image processing apparatus 1 receives the image data by the NIC 234 (S507), and the main CPU 211 stores the received image data in the image memory 216 (S508).

In step S505, if the first authentication information does not match the second authentication information stored in the storing section 53 (S505: NO), the CPU 51 causes the communication section 54 to transmit the determination result indicating that the first authentication information and the second authentication information do not match to the image processing apparatus 1 (S509). The image processing apparatus 1 receives the determination result by the NIC 234 (S510), and the main CPU 211 displays an error message indicating that the image data can not be retrieved in the display section 220a of the control panel 220 according to the received determination result (S511).

Here, the image processing apparatus 1 completes the image data retrieving process. According to an instruction inputted by the user by operating the receiving section 220b of the control panel 220, the image processing apparatus 1 executes various kinds of imaging processing by using the image data stored in the image memory 216. For example, the image processing apparatus 1 performs the process of forming an image based on the retrieved image data, the process of storing the image data in the storage device 3, or the process of transmitting the image data to an arbitrary PC 4.

In this embodiment, as described in detail above, when the image processing apparatus 1 tries to store image data in the storage device 3 but cannot store the image data, it transmits the first authentication information for authenticating the storage device 3 to the authentication server apparatus 5. The authentication server apparatus 5 determines whether or not the first authentication information received from the image processing apparatus 1 matches the stored second authentication information. If the first authentication information and the second authentication information match, the image processing apparatus 1 transmits the image data to the authentication server apparatus 5, and the authentication server apparatus 5 stores the image data. Moreover, in this embodiment, the image processing apparatus 1 retrieves the image data from the authentication server apparatus 5 authenticated by the second authentication information that matches the first authentication information.

In this embodiment, even when the image data cannot be stored due to a shortage of the storage capacity of the storage device 3, the image data is transferred to the authentication server apparatus 5 without requiring the user to perform complicated operations, and therefore the operability of the image processing apparatus 1 is improved. Moreover, when retrieving image data, the image data can be easily retrieved from the authentication server apparatus 5 by just connecting the storage device 3, and thus it is possible to easily use the stored image data.

Note that the information processing system may be embodied to perform a combination of the processes of Embodiments 2 and 3. In other words, the image processing system may be embodied to execute the processes in and after step S406 when neither of the second authentication information for authenticating the storing section 215 nor the second authentication information for authenticating the PC 4 matches the first authentication information. The information processing system may be embodied to perform the process using the transfer destination information that is used in Embodiment 1. More specifically, in this embodiment, the information processing system performs the processes in and after step S406 when the storage device 3 stores the transfer destination information indicating the authentication server apparatus 5.

Although Embodiments 2 and 3 described above illustrate the process of determining whether the first authentication information and the second authentication information correspond to each other, based on whether or not the first authentication information and the second authentication information match each other, the method of determining correspondence is not limited to this. In other words, it may be possible to perform the process of determining whether or not the first authentication information and the second authentication information correctly correspond to each other by other method, such as by determining whether or not it is possible to correctly decrypt the first authentication information as encrypted data by the second authentication information as a decryption key.

Although Embodiments 1 to 3 described above illustrate the process of transferring image data when the storage device 3 does not have sufficient storage capacity, it may be possible to also perform the process of transferring the image data when the storage device 3 has a trouble, or when the storage device 3 cannot store the image data for some other reason.

In Embodiments 1 to 3 described above, the image processing apparatus 1 is illustrated as a multi-function peripheral capable of copying a document image, forming an image based on image data, and reading an image, but the image processing apparatus 1 is not limited to this. For example, the image processing apparatus 1 may be a multi-function peripheral further having a facsimile function. Or the image processing apparatus 1 may be a scanner apparatus that main reads images. Even this embodiment can realize the image processing apparatus if it has a function for attaching the storage device 3.

In Embodiments 1 to 3 described above, although the storage device 3 is a USB memory, the storage device 3 is not limited to this, and it may be possible to use other device connectable to the connection section 231, such as a notebook type PC, a storage device, a PDA, or a cell phone having memory means such as a semiconductor memory or a hard disk, as the storage device 3. Further, although Embodiments 1 to 3 described above illustrate examples in which the storage device 3 is used as a storage medium, the storage device 3 is not limited to this, and it may be possible to use other storage medium, such as a memory card, a magnetic disk or an optical disk, as the storage medium. In this example, the image processing apparatus 1 comprises means for installing a storage medium, such as a slot for a memory card.

As this description may be embodied in several forms without departing from the spirit of essential characteristics thereof, the present embodiments are therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An information processing apparatus capable of attaching a removable storage medium thereto and storing data in the attached storage medium, comprising a controller capable of:
determining whether or not data to be stored can be stored in the attached storage medium;
when it is determined that the data cannot be stored, determining whether or not transfer destination information indicating a transfer destination of the data is stored in said storage medium; and
when it is determined that the transfer destination information is stored in the storage medium, transferring the data to the transfer destination indicated by the transfer destination information stored in the storage medium.

2. The information processing apparatus according to claim 1, wherein
the data to be stored in said storage medium is image data, and
said information processing apparatus further comprises an image generating section for generating image data by reading a document image.

3. An information processing apparatus capable of attaching a removable storage medium thereto and storing data in the attached storage medium, comprising:
means for determining whether or not data to be stored can be stored in the attached storage medium;
means for, when it is determined that the data cannot be stored, determining whether or not transfer destination information indicating a transfer destination of the data is stored in said storage medium; and
means for transferring the data to the transfer destination indicated by the transfer destination information stored in the storage medium when it is determined that the transfer destination information is stored in the storage medium.

4. The information processing apparatus according to claim 3, wherein
the data to be stored in said storage medium is image data, and
said information processing apparatus further comprises means for generating image data by reading a document image.

5. An information processing apparatus capable of attaching a removable storage medium thereto and storing data in the attached storage medium, comprising a controller capable of
determining whether or not data to be stored can be stored in the attached storage medium;
when it is determined that the data cannot be stored, determining whether or not first authentication information for authenticating said storage medium is stored in said storage medium;
when it is determined that the first authentication information is stored in said storage medium, determining whether or not the first authentication information and second authentication information for authenticating a transfer destination of the data correctly correspond to each other; and
when it is determined that the first authentication information and the second authentication information correctly correspond to each other, transferring the data to the transfer destination authenticated by the second authentication information that correctly corresponds to the first authentication information.

6. The information processing apparatus according to claim 5, further comprising:
a first storing section capable of storing data; and
a second storing section for storing second authentication information for authenticating the first storing section,
wherein said transfer destination is the first storing section.

7. The information processing apparatus according to claim 5, wherein
said transfer destination is an external storage apparatus,
said information processing apparatus further comprises a receiving section for receiving second authentication information transmitted from the external storage apparatus, and
said controller is further capable of determining whether or not the first authentication information and the received second authentication information correctly correspond to each other.

8. The information processing apparatus according to claim 5, wherein said transfer destination is an external storage apparatus, and said information processing apparatus further comprises:
a transmitting section for transmitting the first authentication information to the external storage apparatus; and
a receiving section for receiving from the external storage apparatus a determination result indicating whether or not the first authentication information and second authentication information for authenticating said storage apparatus correctly correspond to each other.

9. The information processing apparatus according to claim 5, further comprising a receiving section for receiving an instruction to retrieve data transferred to the transfer destination in a state in which the storage medium is attached,
wherein said controller is further capable of:
determining whether or not the first authentication information and the second authentication information for authenticating the transfer destination correctly correspond to each other when said receiving section receives the instruction, and
when it is determined that the first authentication information and the second authentication information correctly correspond to each other, obtaining the data from the transfer destination authenticated by the second authentication information that correctly corresponds to the first authentication information.

10. The information processing apparatus according to claim 5, wherein the data to be stored in said storage medium is image data, and said information processing apparatus further comprises an image generating section for generating image data by reading a document image.

11. An information processing apparatus capable of attaching a removable storage medium thereto and storing data in the attached storage medium, comprising:
means for determining whether or not data to be stored can be stored in the attached storage medium;
means for, when it is determined that the data cannot be stored, determining whether or not first authentication information for authenticating said storage medium is stored in the storage medium;
determination means for, when it is determined that the first authentication information is stored in said storage medium, determining whether or not the first authentication information and second authentication information for authenticating a transfer destination of the data correctly correspond to each other; and
means for transferring the data to the transfer destination authenticated by the second authentication information that correctly corresponds to the first authentication information when it is determined that the first authentication information and the second authentication information correctly correspond to each other.

12. The information processing apparatus according to claim 11, further comprising:
a storing section capable of storing data; and
means for storing second authentication information for authenticating said storing section,
wherein said transfer destination is the storing section.

13. The information processing apparatus according to claim 11, wherein
said transfer destination is an external storage apparatus,
said information processing apparatus further comprises means for receiving second authentication information transmitted from the external storage apparatus, and
said determination means determines whether or not the
first authentication information and the received second authentication information correctly correspond to each other.

14. The information processing apparatus according to claim 11, wherein
said transfer destination is an external storage apparatus, and
said information processing apparatus further comprises:
means for transmitting the first authentication information to said external storage apparatus; and
means for receiving from said external storage apparatus a determination result indicating whether or not the first authentication information and second authentication information for authenticating said storage apparatus correctly correspond to each other.

15. The information processing apparatus according to claim 11, further comprising receiving means for receiving an instruction to retrieve data transferred to the transfer destination in a state in which the storage medium is attached,
wherein said determination means determines whether or not the first authentication information and the second authentication information for authenticating the transfer destination correctly correspond to each other when said receiving means receives the instruction, and
said information processing apparatus further comprises means for obtaining the data from the transfer destination authenticated by the second authentication information that correctly corresponds to the first authentication information when it is determined that the first authentication information and the second authentication information correctly correspond to each other.

16. The information processing apparatus according to claim 11, wherein
the data to be stored in said storage medium is image data, and
said information processing apparatus further comprises means for generating image data by reading a document image.

17. An information processing system comprising:
an information processing apparatus capable of attaching a removable storage medium thereto and storing data in the attached storage medium; and
a storage apparatus connected to said information processing apparatus, wherein
said information processing apparatus includes:
a controller capable of:
determining whether or not data to be stored can be stored in the attached storage medium; and
when it is determined that the data cannot be stored, determining whether or not first authentication information for authenticating said storage medium is stored in said storage medium; and
a transmitting section for transmitting the first authentication information to said storage apparatus when it is determined that the first authentication information is stored in said storage medium, and
said storage apparatus includes:
a storing section for storing second authentication information for authenticating the storage apparatus;
a controller capable of determining whether or not the first authentication information received from said information processing apparatus and the second authentication information correctly correspond to each other; and
a transmitting section for transmitting a result of determination made by said controller to said information processing apparatus, and
wherein, when the determination result received from said storage apparatus is a result of determination indicating that the first authentication information and the second authentication information correctly correspond to each other, the transmitting section of said information processing apparatus transmits the data to said storage apparatus, and
the storing section of said storage apparatus stores the data received from said information processing apparatus.

18. An information processing system comprising:
an information processing apparatus capable of attaching a removable storage medium thereto and storing data in the attached storage medium; and
a storage apparatus connected to said information processing apparatus, wherein
said information processing apparatus includes:
means for determining whether or not data to be stored can be stored in the attached storage medium;
means for, when it is determined that the data cannot be stored, determining whether or not first authentication information for authenticating said storage medium is stored in said storage medium; and
means for transmitting the first authentication information to said storage apparatus when it is determined that the first authentication information is stored in said storage medium,
said storage apparatus includes:
means for storing second authentication information for authenticating the storage apparatus;
means for determining whether or not the first authentication information received from said information processing apparatus and the second authentication information correctly correspond to each other; and
means for transmitting a result of determination made by said means to said information processing apparatus, said information processing apparatus further includes means for transmitting the data to said storage apparatus when the determination result received from said storage apparatus is a result of determination indicating that the first authentication information and the second authentication information correctly correspond to each other, and
said storage apparatus further includes means for storing the data received from said information processing apparatus.
